(19) United States
(12) Patent Application Publication
(10) Pub. No.: US 2025/0385587 A1
(43) Pub. Date: Dec. 18, 2025

(54) THERMOMAGNETIC POWER GENERATION USING AN OSCILLATING HEAT PIPE

(71) Applicant: Iowa State University Research Foundation, Inc., Ames, IA (US)

(72) Inventors: Jun Cui, Ames, IA (US); Todd A. Kingston, Ames, IA (US); Shantanu Datar, Ames, IA (US)

(73) Assignee: Iowa State University Research Foundation, Inc., Ames, IA (US)

(21) Appl. No.: 19/233,955

(22) Filed: Jun. 10, 2025

Related U.S. Application Data
(60) Provisional application No. 63/659,641, filed on Jun. 13, 2024.

(51) Int. Cl. H02K 35/02; F28D 15/02

(52) U.S. Cl. CPC H02K 35/02; F28D 15/0266

(57) ABSTRACT

An oscillating heat pipe (OHP) generator is provided. The OHP generator includes a conduit defining a continuous, meandering circuit, a working fluid disposed within the conduit in which the working fluid includes a liquid phase and a vapor phase, and a generator section of the conduit. The generator section includes a magnet disposed within the conduit and one or more conducting coils wrapped around the conduit. In operation, the generator section is arranged parallel to a ground plane.

### CROSS-REFERENCE TO RELATED PATENT APPLICATIONS

This patent application claims the benefit of U.S. Provisional Patent Application No. 63/659,641, filed Jun. 13, 2024, the entire teachings and disclosure of which are incorporated herein by reference thereto.

### STATEMENT REGARDING FEDERALLY SPONSORED RESEARCH AND DEVELOPMENT

This invention was made with government support under DE-AC02-07CH11358 awarded by the Department of Energy and under 80NSSC22M0233 awarded by the National Aeronautics and Space Administration. The government has certain rights in the invention.

### FIELD OF THE INVENTION

This invention generally relates to oscillating heat pipes and, in particular, to an oscillating heat pipe configured to generate electricity through captured low-grade waste heat.

### BACKGROUND OF THE INVENTION

According to a 2008 DOE ITP report on waste heat recovery, it was estimated that roughly 60% of unrecovered waste heat is low grade (i.e., at temperatures below 230° C.). Further the report concluded that, while low temperature waste heat has less thermal and economic value than high temperature heat, it is ubiquitous and available in large quantities. For example, data centers use up to 2% of US electricity and half of the energy is dumped as waste heat at about 80° C. Compared to the high grade (>650° C.) and medium grade (230-650° C.) waste heat, for which conventional methods such as steam and organic Rankine cycles can be utilized for power generation with reasonably high efficiency, the conversion of low-grade waste heat to electricity has intrinsically low Carnot efficiency (<20%).

While it is the most efficient if the low-grade waste heat is transferred to the location where it can be directly used as heat, it is more useful and impactful if it can be converted to electricity. Thus, the inventors have recognized a need to provide cost-effective and energy efficient conversion of low-grade waste heat to electricity. However, thermoelectric conversion is not a preferred technology for low grade waste heat recovery, not because of its low efficiency, but because of its cost, which has conventionally been around $20/W. For any power-generation technology to be economically feasible, the cost should be lower than $1/W.

### BRIEF SUMMARY OF THE INVENTION

In a first aspect, embodiments of the present disclosure relate to an oscillating heat pipe (OHP) generator. The OHP generator comprises a conduit defining a continuous, meandering circuit, a working fluid disposed within the conduit in which the working fluid includes a liquid phase and a vapor phase, and a generator section of the conduit. The generator section includes a magnet disposed within the conduit and one or more conducting coils wrapped around the conduit. In operation, the generator section is arranged parallel to a ground plane.

In a second aspect, embodiments of the present disclosure relate to the OHP generator according to the first aspect in which the conduit comprises a plurality of conduit sections, at least one first end turn, at least one second end turn, and a return line. The conduit sections are alternatingly connected at a first end by the at least one first end turn and at a second end by the at least one second end turn, and a last conduit section of the plurality of conduit sections is connected to a first conduit section of the plurality of conduit sections by the return line.

In a third aspect, embodiments of the present disclosure relate to the OHP generator according to the second aspect in which the generator section is disposed in the return line.

In a fourth aspect, embodiments of the present disclosure relate to the OHP generator according to the third aspect in which the magnet is confined to a section of the return line.

In a fifth aspect, embodiments of the present disclosure relate to the OHP generator according to the first aspect or the second aspect in which the generator section comprises a plurality of generator sections distributed over the conduit.

In a sixth aspect, embodiments of the present disclosure relate to the OHP generator according to the fifth aspect in which the magnet can travel throughout the conduit.

In a seventh aspect, embodiments of the present disclosure relate to the OHP generator according to any of the first aspect to the sixth aspect in which the working fluid is selected from a group consisting of water, methanol, ethanol, acetone, and mixtures thereof.

In an eighth aspect, embodiments of the present disclosure relate to the OHP generator according to any of the first aspect to the seventh aspect in which the magnet is selected from a group consisting of a neodymium iron born magnet, a samarium cobalt magnet, an alnico magnet, or a ferrite magnet.

In a ninth aspect, embodiments of the present disclosure relate to the OHP generator according to any of the first aspect to the eighth aspect in which the liquid phase of the working fluid fills from 30% to 80% of a volume of the conduit.

In a tenth aspect, embodiments of the present disclosure relate to the OHP generator according to any of the first aspect to the ninth aspect in which each conductor coil of the one or more conductor coils is configured to generate on average 0.25 μW of electrical power from waste heat having a temperature of 230° C. or less.

In an eleventh aspect, embodiments of the present disclosure relate to the OHP generator according to any of the first embodiment to the tenth embodiment in which the conduit is defined between a base and a cover, the cover being bonded to the base.

In a twelfth aspect, embodiments of the present disclosure relate to the OHP generator according to the eleventh embodiment in which the conduit comprises at least one groove formed in a surface of the conduit.

In a thirteenth aspect, embodiments of the present disclosure relate to the OHP generator according to any of the first aspect to the twelfth aspect in which the magnet comprises an outer surface defining a groove extending around the magnet.

In a fourteenth aspect, embodiments of the present disclosure relate to an installation. The installation comprises one or more OHP generators according to any of the first aspect to the thirteenth aspect. The installation further comprises a source of low-grade waste heat and a heat collection structure having a first temperature of 230° C. or less. The heat collection structure being in thermal communication with the source of low-grade waste heat and with a first end of the one or more OHP generators. A second end of the one or more OHP generators is disposed in a cooling environment having a second temperature, and the second temperature is less than the first temperature.

In a fifteenth aspect, embodiments of the present disclosure relate to the installation according to the fourteenth aspect in which the installation is a datacenter or a space platform and the source of low-grade waste heat is electronic components.

In a sixteenth aspect, embodiments of the present disclosure relate to the installation according to the fourteenth aspect or the fifteenth aspect in which the cooling environment is ambient atmosphere.

In a seventeenth aspect, embodiments of the present disclosure relate to the installation according to the fourteenth aspect or the fifteenth aspect in which the cooling environment is a fluid bath.

In an eighteenth aspect, embodiments of the present disclosure relate to the installation according to the fourteenth aspect or the fifteenth aspect in which the cooling environment is an interface with a coolant system.

In a nineteenth aspect, embodiments of the present disclosure relate to a method of producing electrical power from low-grade waste heat. In the method, a first end of an oscillating heat pipe (OHP) generator according to any of the first aspect to the thirteenth aspect is arranged in proximity to a source of the low-grade waste heat that produces waste heat a first temperature. A second end of the OHP generator is arranged in a cooling environment having a second temperature, and the second temperature is less than the first temperature. The working fluid is oscillated through the conduit to cause the magnet within the generator section to pass through the one or more conducting coils to generate the electrical power.

In a twentieth aspect, embodiments of the present disclosure relate to the method according to the nineteenth aspect in which each conducting coil is configured to generate, on average, at least 0.25 μW of electrical power.

In a twenty-first aspect, embodiments of the present disclosure relate to the method according to the nineteenth aspect or the twentieth aspect in which the source of the low-grade waste heat is electronic components in a datacenter or a space platform.

In a twenty-second aspect, embodiments of the present disclosure relate to the method according to the nineteenth aspect or the twentieth aspect in which the cooling environment is ambient atmosphere, a fluid bath, or an interface with a coolant system.

In a twenty-third aspect, embodiments of the present disclosure relate to the method according to any of the nineteenth aspect to the twenty-second aspect in which, during oscillating, the magnet is confined to a section of the conduit.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic depiction of an oscillating heat pipe having a waste heat generating section with a horizontal orientation, according to one or more embodiments of the present disclosure;

FIG. 2 is a schematic depiction of an oscillating heat pipe in which the entire oscillating heat pipe acts as generating section, according to one or more embodiments of the present disclosure;

FIG. 3 is a schematic depiction of an installation including an oscillating heat pipe, according to one or more embodiments of the present disclosure;

FIGS. 4 and 5 depict an oscillating heat pipe microfluidic device, according to one or more embodiments of the present disclosure;

FIG. 6 depicts an oscillating heat pipe microfluidic device having a plurality of generator sections, according to one or more embodiments of the present disclosure;

FIG. 7 depicts a system for charging the oscillating heat pipe microfluidic device with a working fluid, according to one or more embodiments of the present disclosure;

FIG. 8 depicts an experimental setup for testing an oscillating heat pipe, according to one or more embodiments of the present disclosure;

FIG. 9 is a graph depicting the temperature of the heated end, cooled end, and adiabatic section and the internal pressure of the oscillating heat pipe, according to one or more embodiments of the present disclosure;

FIG. 10 is a graph of the voltage and current induced in the generating section of the experimental oscillating heat pipe as a result of oscillations of the working fluid that cause the magnet to oscillate, according to one or more embodiments of the present disclosure;

FIGS. 11A and 11B are graphs of voltage and pressure oscillations for an oscillating heat pipe in which the magnetic ball includes a circumferential groove (FIG. 11A) and in which the magnetic ball does not include a circumferential groove (FIG. 11B), according to one or more embodiments of the present disclosure;

FIGS. 12A and 12B are graphs of current oscillations for an oscillating heat pipe in which the magnetic ball includes a circumferential groove (FIG. 12A) and in which the magnetic ball does not include a circumferential groove (FIG. 12B), according to one or more embodiments of the present disclosure; and

FIG. 13 is a photograph of a ball magnet having a circumferential groove, according to one or more embodiments of the present disclosure.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

Reference will now be made in detail to various embodiments of an oscillating heat pipe generator and method of using same for the capture of low-grade waste heat (e.g., heat having a temperature of <230° C.), examples of which are illustrated in the accompanying drawings. As will be described more fully below, the oscillating heat pipe generator is a continuous, meandering flow path or circuit containing a working fluid. The working fluid includes liquid slugs and vapor plugs that, when heated with low-grade waste heat, expand and contract to cause oscillations of the working fluid within the conduit. The oscillating heat pipe includes at least one generator section having contained therein one or more magnets, and the oscillations of the working fluid cause the magnets to move back-and-forth through conductor coils, generating electric power. Surprising and unexpectedly, the inventors found that orienting the generator section horizontally, or parallel to a ground plane, allowed for a significant increase in the amount of power that could be generated from the low-grade waste heat. The inventors envision that the oscillating heat pipe according to the present disclosure is particularly suitable for datacenter and low-gravity space applications. These and other aspects and advantages of the disclosed oscillating heat pipe and method of using same will be described in relation to the embodiments provided below and shown in the drawings. These embodiments are presented by way of example and not by way of limitation.

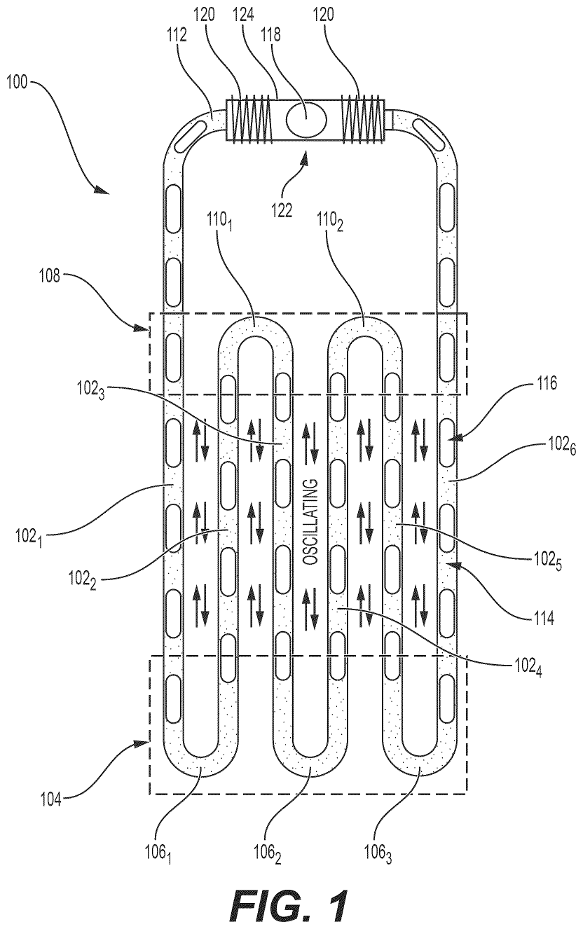

FIG. 1 depicts an embodiment of an oscillating heat pipe (OHP) generator 100 according to an embodiment of the present disclosure. The OHP generator 100 includes a plurality of conduit sections (generally, “conduit sections 102” and specifically, “conduit sections 102₁-102₆”) that are connected at a first end 104 by a plurality of first end turns (generally, “first end turns 106” and specifically, “first end turns 106₁-106₃”) and at a second end 108 by a plurality of second end turns (generally, “second end turns 110” and specifically, second end turns 110₁, 110₂”). In particular, odd conduit sections 102_{1,3,5} are connected to even conduit sections 102_{2,4,6} by the first end turns 106_{1,2,3}, and all but the last even conduit sections 102_{2,4} are connected to the next adjacent odd conduit sections 102_{3,5} by the second end turns 110_{1,2}. The final even conduit section 102₆ is connected to the first odd conduit section 102₁ by a return line 112. In this way, the OHP generator 100 is one continuous, meandering circuit. While the conduit sections 102, turns 106, 110, and return line 112 of the OHP generator 100 are depicted as being formed from a unitary material, individual sections could be joined and sealed using various fittings or joining techniques.

As can be seen in FIG. 1, the first conduit section 102₁ is connected to the second conduit section 102₂ at the first end 104 by the first first end turn 106₁, and the second conduit section 102₂ is connected to a third conduit section 102₃ at the second end 108 by the first second end turn 110₁. In one or more embodiments, the conduit sections 102₁-102₆ are in a parallel and planar arrangement as shown in FIG. 1. In one or more embodiments, the return line 112 is disposed in the same plane as the conduit sections 102₁-102₆, and in one or more other embodiments, the return line 112 is disposed in a different plane (e.g., in front of or behind) than the plane of the conduit sections 102₁-102₆. Additionally, in one or more embodiments, the conduit sections 102 may be in a bundled configuration (e.g., the conduit sections 102 arranged adjacently in plane or out of plane) or in a coiled, helical, or otherwise winding configuration (e.g., with the ends of the coil, helix, or winding joined by the return line 112).

In one or more embodiments, the OHP generator 100 includes at least two conduit sections 102. In one or more embodiments, the OHP generator 100 includes conduit sections 102 in an amount in a range from two to one hundred. In one or more embodiments, the number of conduit sections 102 is an even number. In one or more embodiments, the number of first end turns 106 is half of the number of conduit sections 102, and the number of second end turns 110 is one less than the number of first end turns 106.

The OHP generator 100 includes a working fluid with a liquid phase and a vapor phase. In particular, the liquid phase is a plurality of liquid slugs 114, and the vapor phase is a plurality of vapor plugs 116 disposed between the liquid slugs 114. In the depiction shown in FIG. 1, all of the vapor plugs 116 are substantially the same size, but in actuality, the size of the vapor plugs 116 at any given time will vary across the OHP generator 100 and over the operational life of the OHP generator 100. As will be discussed more fully, the OHP generator 100 operates by oscillating the liquid slugs 114 and vapor plugs 116 of the working fluid. In one or more embodiments, the working fluid may be but is not limited to, water, methanol, ethanol, acetone, or mixtures thereof. In one or more embodiments, the working fluid is charged in the OHP generator 100 at a fill ratio in a range from about 30% to about 80%, in particular about 50%. That is, the working fluid fills from 30% to about 80%, in particular about 50%, of an internal volume of the OHP generator 100. Prior to charging the OHP generator 100 with the working fluid, the OHP generator 100 is evacuated to a vacuum of approximately 2 kPa absolute pressure or less.

One of the first end 104 or the second end 108 is heated with low-grade waste heat, and the other of the first end 104 or the second end 108 is cooled. In the embodiment depicted in FIG. 1, the first end 104 is heated, and the second end 108 is cooled. The heated end acts as an evaporator that increases the size of the vapor plugs 116, which pushes the liquid plugs 114 outwardly in each direction within the OHP generator 100. The cooled end acts as a condenser that decreases the size of the vapor plugs 116, which pulls the liquid plugs 114 inwardly in each direction within the OHP generator 100. The expansion and contraction of the vapor plugs 116 by the heated end and cooled end creates an oscillating motion of the working fluid within the OHP generator 100.

According to an embodiment of the present disclosure, this oscillating motion is used to generate electricity by the OHP generator 100 by moving a magnet 118 through one or more conductor coils 120 in a generator section 122. That is, oscillation of the working fluid moves the magnet 118 through the conductor coils 120, which induces a voltage in the conductor coils 120 according to Faraday's Law. In one or more embodiments, the magnet 118 can be any permanent magnet with a Curie temperature above the working fluid temperature, such as a neodymium-iron-boron (Nd—Fe—B) based magnet, samarium-cobalt (Sm—Co) based magnet, aluminum-nickel-cobalt (Alnico) based magnets, and ferrite, among other possibilities.

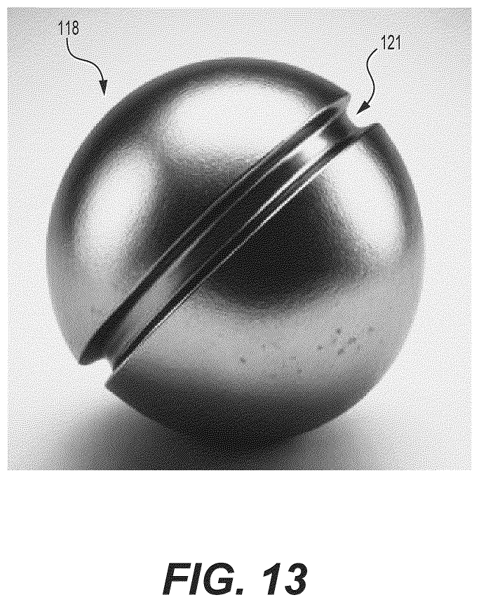

In one or more embodiments, the magnet 118 includes a groove 121 formed in outer surface as shown in FIG. 13. In one or more embodiments, the groove 121 extends around the circumference of the magnet. In one or more embodiments, the groove 121 has a depth of from 5% to 30%, in particular 10% to 20% of the diameter of the magnet 118. For example, the depth of the groove may be 0.5 mm for a magnet 118 have a diameter of 3 mm. Further, in one or more embodiments, the groove 121 has cross-sectional shape selected from square, rectangular, or semicircular, amongst other possibilities. As will be discussed more fully below, the groove 121 on the magnet 118 may help to increase the number of oscillations

In experimenting with designs of the OHP generator 100, the inventors found that the orientation of the generator section 122 had a surprising and unexpected effect on the achievable power output. In particular, the inventors found that orienting the generator section 122 substantially horizontally, i.e., substantially parallel to a ground plane, produced an enhancement in power generation of about 100×. That is, compared to a substantially vertical (i.e., substantially perpendicular to the ground plane) orientation, the horizontally oriented generator section is able to produce 100× more power output at the same level of power input. Accordingly, the disclosed OHP generator 100 provides substantially enhanced recovery of low-grade waste heat than conventional designs. The inventors surmise that the surprising and better than expected level of power generation results at least in part from the reduced effect of gravity on the magnet 118 moving in the generator section 122. Further, the horizontal orientation of the generator section 122 limits the effect of the magnet 118 on the thermophysical properties of the working fluid with respect to its ability to rapidly oscillate, which allows the magnetic ball 118 to move through the conductor coils 120 more times, generating more electricity.

In one or more embodiments, such as the embodiment shown in FIG. 1, the magnet 118 is confined to a chamber 124 within the OHP generator 100. In the embodiment shown, the diameter of the chamber 124 is larger than the diameter of the return line 112 in which it is disposed. The magnet 118 is sized to move within the chamber 124 without being able to enter the return line 112, thereby confining the magnet 118 to the chamber. In such an arrangement, the orientation of the conduit sections 102₁-102₆, first end turns 106₁-106₃, and second end turns 110₁, 110₂ is not critical so long as the generator section 122 is arranged horizontally.

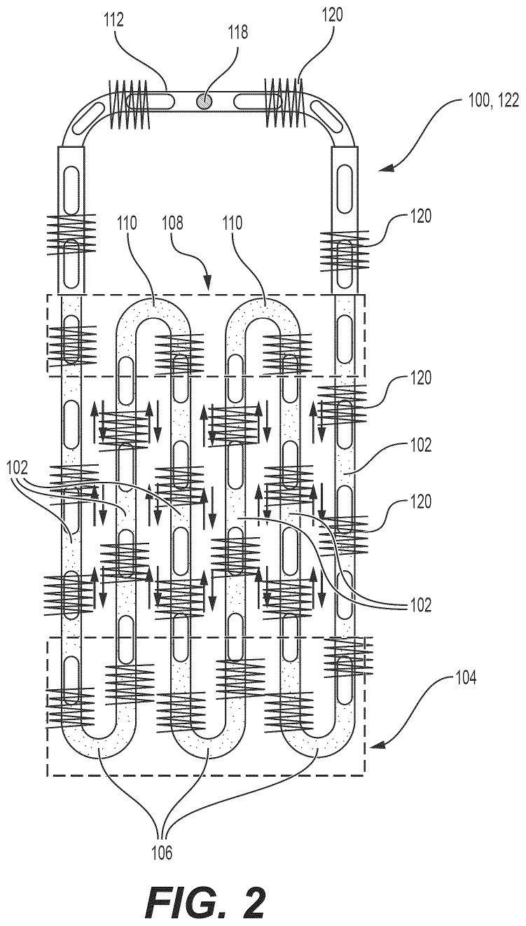

However, in one or more other embodiments, the magnet 118 is not confined to a chamber 124 and may travel throughout the OHP generator 100. In such an embodiment, an example of which is depicted in FIG. 2, a plurality of conductor coils 120 is provided throughout the OHP generator 100 such that the entire OHP generator 100 is a generator section 122. To take advantage of the enhanced power generation, the entire OHP generator 100 is oriented horizontally. That is, the plane defined by the conduit sections 102, first end turns 106, second end turns 110, and return line 112 is oriented substantially parallel to the plane of the ground. In such an embodiment, the OHP generator 100 may include a plurality of magnets scattered and oscillating throughput the conduit sections 102, end turns 106, 110, and return line 112.

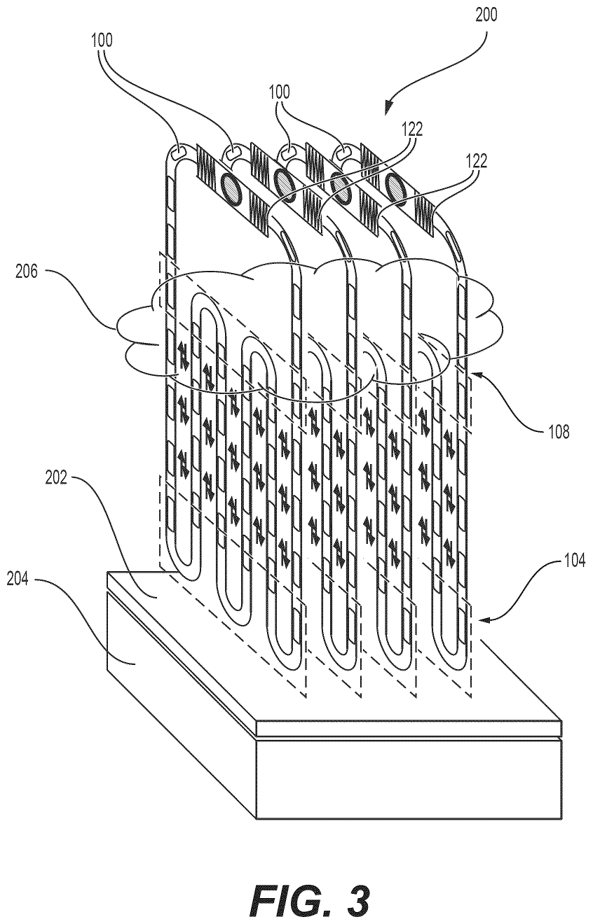

As shown in FIG. 3, in a given installation 200, one or more OHP generators 100 are in thermal communication with a heat collection structure 202 at the heated end, which is depicted as the first end 104. In one or more embodiments, the heat collection structure 202 is thermally connected to the low-grade waste heat generating source 204, which may be any of a variety of processes or devices that generate low-grade waste heat as a byproduct of operation. For example, the waste heat generating source 204 may be electronic components, such as CPUs or GPUs in a datacenter, and the collection structure 202 may be a plate that acts as a heat sink for the heat generated by the electronic components. The heat collection structure 202 transfers the heat to the first end 104 of the one or more OHP generators 100, which causes expansion of the vapor plugs 116 as discussed above. The second end 108 of the one or more OHP generators 100 is disposed in a cooling environment 206, such as the ambient atmosphere, a fluid bath, or in thermal communication with a coolant system. For example, the second end 104 may be positioned at a distance sufficient from the first end 108 that the surrounding atmosphere is at a significantly different temperature to provide cooling of the working fluid through dissipation of the heat in the surrounding atmosphere, contracting the vapor plugs 116 as discussed above. In the installation, each generator section 122 is placed and oriented so as to be substantially horizontal. By using a plurality of OHP generators 100, each of the OHP generators 100 can include a generator section 122 to generate electric power from the waste heat.

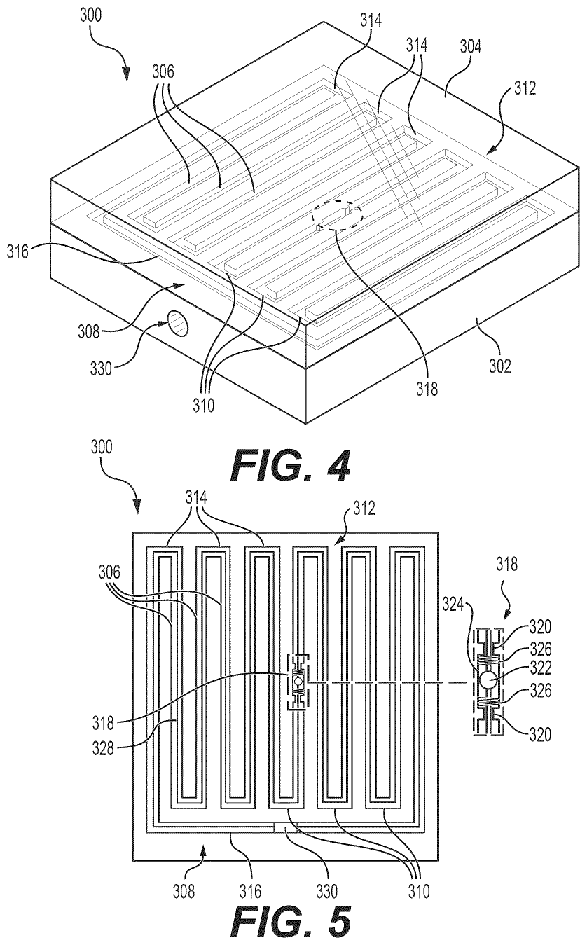

FIGS. 4-7 depict another example of an OHP generator 300 according to embodiments of the present disclosure. In one or more embodiments, the OHP generator is a miniaturized version that is in the form of a fluidic chip, in particular a microfluidic chip. Waste heat often originates from small areas, such as from electronic devices, so having a small, compact OHP generator 300 allows for capturing of waste heat in these spaces. Moreover, the compact OHP generator 300 is lighter and smaller, thus having weight and volume savings, which may be important for certain applications.

In one or more embodiments, the OHP generator 300 is formed from a base 302 and a cover 304. The base 302 and the cover 304 cooperate to form conduit sections 306. In one or more embodiments, the conduit sections 306 are machined, molded, printed, or otherwise formed into the base 302 with the cover 304 serving as a top to the conduit sections 306. In one or more other embodiments, the conduit sections 306 are machined, molded, printed, or otherwise formed into the cover 304 with the base 302 serving as a bottom to the conduit sections 306. In still one or more other embodiments, the conduit sections 306 are partially machined, molded, printed, or otherwise formed into the base 302 and partially machined, molded, printed, or otherwise formed into the cover 304 such that the base 302 and cover 304 each define a portion of the sidewalls of the conduit sections 306.

In one or more embodiments, the base 302 and the cover 304 are formed from the same material. In one or more embodiments, the base 302 and the cover 304 are formed from different materials. For example, the base 302 and the cover 304 may each be independently formed from a metal, a ceramic, a glass, or a plastic material. In the embodiment shown in FIGS. 4-6, the base 302 is metal, in particular stainless steel, and the cover 304 is glass, which allows for visualization of the conduit sections 306 during operation of the OHP generator 300.

In one or more embodiments, the OHP generator 300 defines a rectangular perimeter. In one or more embodiments, side lengths of the OHP generator 300 may be 200 mm or less. For example, the side lengths of the OHP generator 300 as shown in FIGS. 4 and 5 may be 150 mm or less, in particular 125 mm or less.

In general, the OHP generator 300 operates in substantially the same manner as the OHP generator 100 as described above in relation to FIGS. 1-3. In particular, the base 302 and cover 304 combine to form a plurality of conduit sections 306 that are connected at a first end 308 by first turns 310 and at a second end 312 by second turns 314. Further, at one of the first end 308 or the second end 312, conduit sections 306 at opposing edges are connected by a return line 316. As discussed above, a generator section 318 is disposed on one or more of the conduit sections 306 or the return line 316. As shown in the embodiment of FIGS. 4 and 5, the generator section 318 is disposed in one of the central conduit sections 306. Further, in the embodiment shown in FIGS. 4 and 5, the OHP generator 300 includes a total of 11 turns (i.e., first turns 310 +second turns 314), but in one or more other embodiments, the OHP generator 300 may include from 5 to 100 total turns or more.

FIG. 5 depicts the generator section in more detail. As can be seen, the generator section 318 is disposed between two restrictions 320 that trap a magnet 322 within a chamber 324. The magnet 322 oscillates within the chamber 324, generating electrical power by passing in and out of coils 326 wrapped around the chamber 324 in the same manner as described above. In FIG. 5, the coils 326 are wrapped around chamber 324, which may be accomplished by drilling through holes through the base 302 and cover 304 and winding a wire around the chamber 324 through the through holes to form the coils 326. In another embodiment, the coils 326 can be disposed in the base 302 and cover 304 with the magnet 322 moving between them to cause current to flow in a manner similar to inductive coupling. In still another embodiment, the coils 326 can be wrapped around the entire OHP generator 300 over the desired regions of the chamber 324 to form the generator section 318.

In one or more embodiments, the restrictions 320 are sized to prevent the magnet 322 from leaving the chamber 324. For example, a spherical magnet 322 having a diameter of 3 mm may be disposed in a conduit section 306 having a depth and width of about 3.5 mm, and the restrictions 320 may have a width of about 2.5 mm. In one or more embodiments, for a spherical magnet 322 having a diameter D, the length of the chamber 324 in which the magnet 322 oscillates is at least 3*D. Thus, for the example embodiment of a spherical magnet 322 having a diameter of 3 mm, the length of the chamber 324 may be about 9 mm.

As can be seen in FIGS. 4 and 5, the conduit sections 306 are angular as opposed to rounded. In one or more embodiments, the conduit sections 306 have a square or rectangular cross-section. It is believed that the corners of the angular conduit sections 306 function as capillary paths that pump liquid from the liquid slug towards the evaporator, which increases the phase change rate in the evaporator and consequently the oscillation amplitude.

Further, in one or more embodiments, the conduit sections 306 include at least one groove 328 formed in at least one surface defining the conduit sections 306. As shown in FIGS. 4 and 5, the at least one groove 328 is formed in a floor of the conduit sections 306. In one or more embodiments, the groove 328 has a width and/or depth of from 5% to 30%, in particular 10% to 20% of the respective width and/or depth of the conduit section 306. For example, the depth/width of the groove 328 may be 0.5 mm for a conduit section 306 having a depth/width of 3.5 mm. Further, in one or more embodiments, the groove 328 has cross-sectional shape selected from square, rectangular, or semicircular, amongst other possibilities. In one or more embodiments, the groove 328 extends along the entire meandering circuit defined by the conduit sections 306, the turns 310, 312, and the return line 316. In one or more other embodiments, the groove 328 extends only in partially through the meandering circuit, either continuously over a section of the meandering circuit or discontinuously in discrete sections along the meandering circuit.

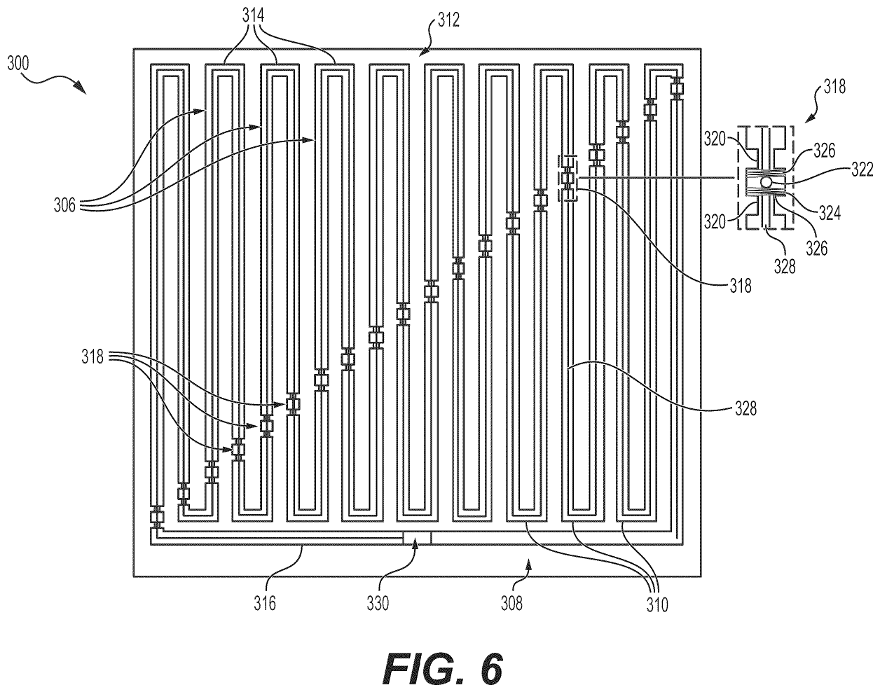

FIG. 6 depicts another embodiment of an OHP generator 300 having a plurality of generator sections 318. In the embodiment shown in FIG. 6, the OHP generator 300 includes 20 generator sections 318 with one generator section 318 disposed on each conduit section 306. Further, in one or more embodiments, in particular where the coils 326 are wrapped around OHP generator 300, the generator sections 318 are arranged diagonally across the face of the base 302 or cover 304, which ensures that only one generator section 318 is positioned at each horizontal location (with respect to the orientation shown in FIG. 6) so that the oscillations of the magnets in the generator sections 318 do not cancel out each other's electromagnetic fields.

In one or more embodiments, the OHP generator 300 having a plurality of generator sections 318 may still have side lengths of 200 mm or less. For example, the OHP generator 300 as shown in FIG. 6 may have side lengths of 190 mm or less, in particular 180 mm or less. In order to accommodate the additional generator sections 318, the side lengths may be 100 mm or more, in particular 150 mm or more.

In each of the embodiments shown in FIGS. 4-6, the cover 304 is bonded to the base 302 using any of a variety of bonding techniques. In one or more embodiments, the cover 304 and base 302 are bonded using anodic bonding techniques, thermocompression bonding, or heated compression (e.g., by a hydraulic press), amongst other possibilities. After bonding the cover 304 to the base 302, the OHP generator 300 is charged with the working fluid. In one or more embodiments, one of the base 302 or the cover 304 includes a charging port 330 in fluid communication with one of the conduit sections 306, turns 308, 312, or return line 316. The working fluid flows through the charging port 330 into the meandering circuit of the OHP generator 300, and then the charging port 330 is sealed during operation of the OHP generator 300.

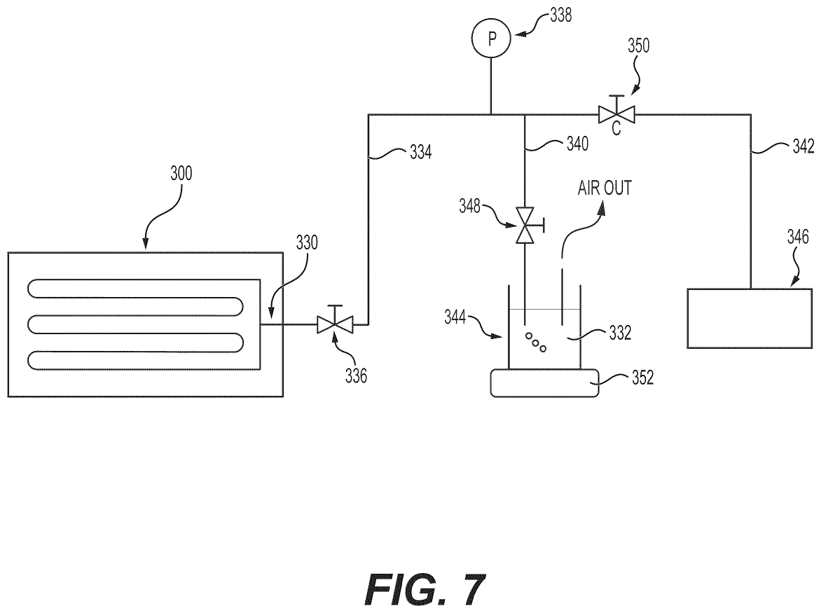

FIG. 7 depicts an exemplary system for charging the OHP generator 300 with working fluid 332. As shown in FIG. 7, a first fluid line 334 is connected to the charging port 330 of the OHP generator 300. In one or more embodiments, the first fluid line 334 is sealed in the charging port 330 using, e.g., a glue, such as Torr Seal TS10 vacuum epoxy. In one or more embodiments, the first fluid line 334 includes a first valve 336 and a pressure transducer 338. The first valve 336 controls flow along the first fluid line 334. Further, in one or more embodiments, the first fluid line 334 branches into a second fluid line 340 and a third fluid line 342. The second fluid line 340 is disposed in a container 344 of the working fluid 332, and the third fluid line 342 is connected to a vacuum pump 346. A second valve 348 is disposed on the second fluid line 340 and controls the flow of fluid on the second fluid line 340. A third valve 350 is disposed on the third fluid line 342 and controls the flow of fluid on the third fluid line 342.

Initially, the second valve 348 is closed, and the first and third valves 336, 350 are open so that the vacuum pump 346 can evacuate the OHP generator 300 to the desired pressure (e.g., 2 kPa or less) as measured by the pressure transducer 338. Upon reaching the desired vacuum, all of the valves 336, 348, 350 are closed. The working fluid 332 is then heated, e.g., using a hot plate 352 or another heating source, to dissolve any entrained air or other gasses. Thereafter, the first and second valves 336, 348 are opened (while keeping the third valve 350 closed), causing the vacuum pressure to suck the working fluid 332 into the OHP generator 300. Once the desired filling ratio of working fluid 332 is reached in the OHP generator 300, the first and second valves 336, 348 are closed.

As mentioned, the OHP generator 300 according to the embodiments shown in FIGS. 4-7 can be miniaturized as compared to the embodiments shown in FIGS. 1-3. That is, the design of the OHP generator 300 can be a microfluidic device having a smaller footprint and operating with less fluid. In this way, the OHP generator 300 can be mounted to such relatively small waste heat generators as electronic components, such as chips or transistor packages. One of the OHP generator 300 is mounted to the desired location, and the other end is mounted to the cooling environment. Additionally, the OHP generators 300 can be cascaded to direct heat to a desired cooling environment, while generating electric power in each OHP generator in the cascading arrangement. As described, the angular cross-section of the meandering flow circuit and the groove 328 in either or both of the magnet 322 and surface of the flow path enhances the amplitude of oscillations, increasing the power generation.

### EXPERIMENTAL EXAMPLES

### Example 1

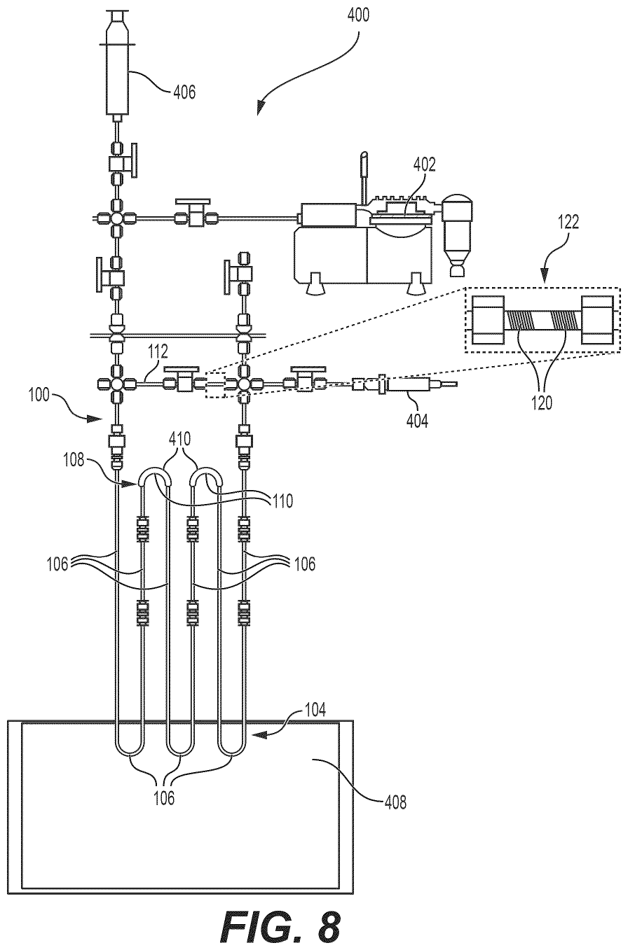

An OHP generator 100 as described above in relation to FIGS. 1-3 was constructed and tested to determine the level of achievable power generation. The experimental setup 400 for the OHP generator 100 is depicted in FIG. 8. As can be seen, the OHP generator 100 includes six conduit sections 102 connected at the first end 104 by three first end turns 106 and at the second end 108 by two second end turns 110. The tubing used to form the OHP generator 100 was stainless steel having an outer diameter of 0.125″ and an inner diameter of 0.055″. The OHP generator 100 was evacuated using a vacuum pump 402 to a vacuum pressure of about 1.6 kPa as measured using a pressure transducer 404. Thereafter, the OHP generator 100 was charged with the working fluid using a fluid injection syringe 406. The working fluid was distilled, deionized, and degassed water, and the fill ratio was about 70%. The pressure in the OHP generator 100 after charging it with the working fluid maintained around 25 kPa.

The generator section 122 included a stainless steel tube having an outer diameter of 0.25″ and an inner diameter of 0.18″. Disposed within the tube was a 0.118″ diameter neodymium iron boron magnet sphere. Two copper conductor coils 120 were wrapped around the tube, and each coil included 2000 turns over a length of about 2 mm. The conductor coils 120 were spaced apart by about 1.5 mm. As can be seen from FIG. 8, the generator section 122 was arranged horizontally at the top of the OHP generator 100.

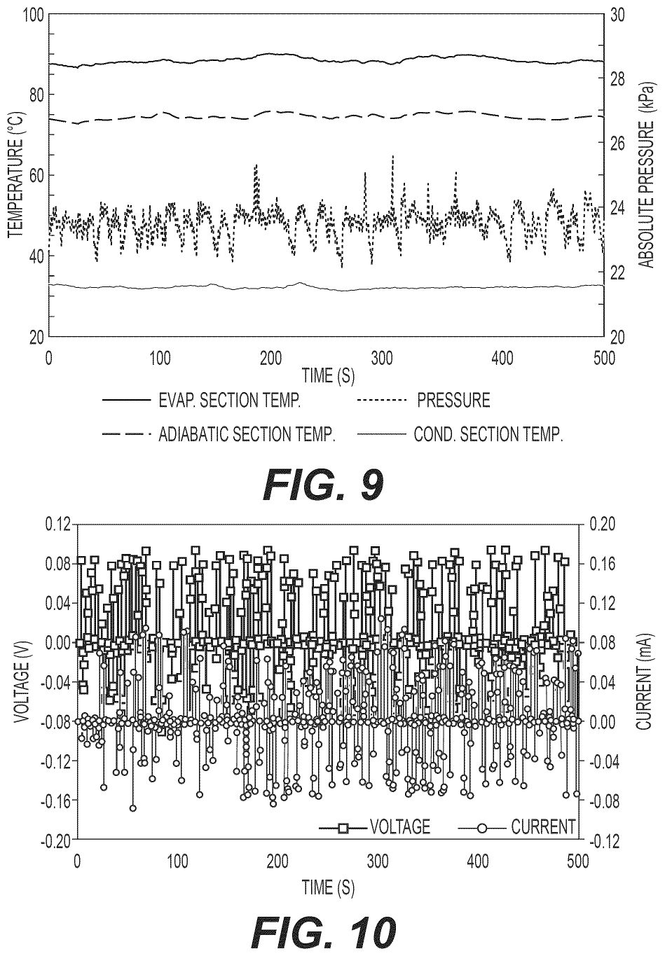

In the experimental setup 400, the first end 104 was disposed in a cooling bath 408, and heater coils 410 were wrapped around the second end turns 110 at the second end 108. The heater coils 410 simulate a source of low-grade waste heat. The heater coils 410 were electrically powered at 30 W per turn to provide a substantially constant temperature of around 88° C. The cooling bath 408 was maintained at a temperature of about 33° C. The return line 112 was positioned above the second, heated end 104 in an adiabatic section that was at a temperature of approximately 74° C. The temperature of the heated end, cooled end, and adiabatic section over 500 seconds is shown in the graph of FIG. 9. The graph of FIG. 9 also includes the pressure fluctuation over the same time period, which was maintained between about 22 kPa and 26 kPa. FIG. 9 demonstrates what was mentioned above, namely that the temperature of each end of the OHP generator 100 were maintained at a substantially constant level over the 500 second time period.

FIG. 10 provides a graph of the voltage and current induced by the oscillations of the working fluid in the OHP generator 100 over the 500 second time period. As can be seen, the voltage alternated at an amplitude of up to about 0.08 V, and the current alternated at an amplitude of up to about 0.17 mA. The RMS voltage was 0.022 V, and the RMS current was 0.02 mA. Averaged over the 500 second time period, an average of 0.25 μW of power was generated per conductor coil. In conventional designs, the generator section is positioned vertically in the tube section between the first end and the second end, and such conventional designs typically produced 0.0025 μW of power per coil. Thus, the OHP generator design according to embodiments of the present disclosure is able to produce 100× more power than the conventional design.

### Example 2

To test the performance of the OHP generator using a grooved magnet, a 0.5 mm groove was made on a spherical magnet having a diameter of 3 mm. The 0.5 mm deep groove in the spherical magnet was manufactured using a square end mill of 0.5 mm. Two tests were conducted with a first test (test-1) using the grooved magnet and the second test (test-2) using a magnet without a groove. The magnets were tested in the OHP generator as described above in Example 1. In each test, the heat input, evaporator and condenser temperatures, and fill ratios were kept the same.

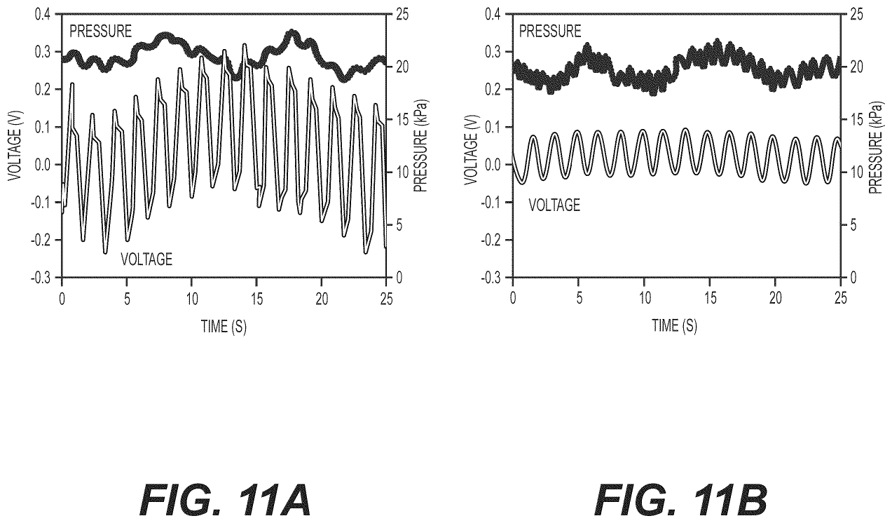

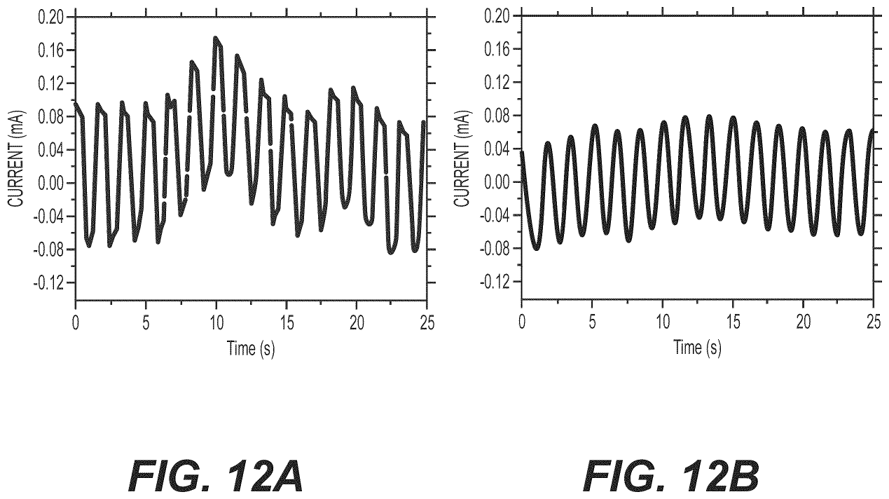

FIGS. 11A and 11B show the output voltage and pressure oscillations vs time for the OHP generator 100 with the grooved magnet and without the grooved magnet, respectively, and FIGS. 12A and 12B show the current vs time for OHP without and with grooved magnet, respectively. The amplitude of hydrodynamic oscillations can be inferred by the voltage, current, and pressure oscillations magnitudes. The pressure oscillations are a result of the expansion and contraction of vapor bubbles in the OHP generator which correlates to the amplitude of voltage and current oscillations. The amplitude of the voltage oscillations for test-1 was 2.5× greater than the amplitude of oscillations of test-2 as shown in FIGS. 11A and 11B, respectively. For test-1, the RMS voltage was 0.088 V as compared to the RMS voltage of 0.043 V for test-2. Further, as shown in FIGS. 12A and 12B, the RMS current was 0.062 mA for test-1 as compared to 0.042 mA for test-2. Accordingly, the output power for test-1 was 5.5 μW, which was about 3× the output power of 1.8 μW for test-2.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An oscillating heat pipe (OHP) generator, comprising:
a conduit defining a continuous, meandering circuit;
a working fluid disposed within the conduit, the working fluid including a liquid phase and a vapor phase; and
a generator section of the conduit;
wherein the generator section includes a magnet disposed within the conduit and one or more conducting coils wrapped around the conduit; and
wherein, in operation, the generator section is arranged parallel to a ground plane.

2. The OHP generator of claim 1, wherein the conduit comprises a plurality of conduit sections, at least one first end turn, at least one second end turn, and a return line, wherein the conduit sections are alternatingly connected at a first end by the at least one first end turn and at a second end by the at least one second end turn, and wherein a last conduit section of the plurality of conduit sections is connected to a first conduit section of the plurality of conduit sections by the return line.

3. The OHP generator of claim 2, wherein the generator section is disposed in the return line.

4. The OHP generator of claim 3, wherein the magnet is confined to a section of the return line.

5. The OHP generator of claim 1, wherein the generator section comprises a plurality of generator sections distributed over the conduit.

6. The OHP generator of claim 5, wherein the magnet can travel throughout the conduit.

7. The OHP generator of claim 1, wherein the working fluid is selected from a group consisting of water, methanol, ethanol, acetone, and mixtures thereof.

8. The OHP generator of claim 1, wherein the magnet is selected from a group consisting of a neodymium iron born magnet, a samarium cobalt magnet, an alnico magnet, or a ferrite magnet.

9. The OHP generator of claim 1, wherein the liquid phase of the working fluid fills from 30% to 80% of a volume of the conduit.

10. The OHP generator of claim 1, wherein each conductor coil of the one or more conductor coils is configured to generate on average 0.25 μW of electrical power from waste heat having a temperature of 230° C. or less.

11. The OHP generator of claim 1, wherein the conduit is defined between a base and a cover, the cover being bonded to the base.

12. The OHP generator of claim 11, wherein the conduit comprises at least one groove formed in a surface of the conduit.

13. The OHP generator of claim 1, wherein the magnet comprises an outer surface defining a groove extending around the magnet.

14. An installation, comprising:
one or more OHP generators according to claim 1;
a source of low-grade waste heat; and
a heat collection structure having a first temperature of 230° C. or less, the heat collection structure being in thermal communication with the source of low-grade waste heat and with a first end of the one or more OHP generators;
wherein a second end of the one or more OHP generators is disposed in a cooling environment having a second temperature, the second temperature being less than the first temperature.

15. The installation of claim 14, wherein the installation is a datacenter or a space platform and the source of low-grade waste heat is electronic components.

16. The installation of claim 14, wherein the cooling environment is ambient atmosphere.

17. The installation of claim 14, wherein the cooling environment is a fluid bath.

18. The installation of claim 14, wherein the cooling environment is an interface with a coolant system.

19. A method of producing electrical power from low-grade waste heat, the method comprising:
arranging a first end of an oscillating heat pipe (OHP) generator according to claim 1 in proximity to a source of the low-grade waste heat that produces waste heat a first temperature;
arranging a second end of the OHP generator in a cooling environment having a second temperature, the second temperature being less than the first temperature;
oscillating the working fluid through the conduit to cause the magnet within the generator section to pass through the one or more conducting coils to generate the electrical power.

20. The method of claim 19, wherein each conducting coil is configured to generate, on average, at least 0.25 μW of electrical power.

21. The method of claim 19, wherein the source of the low-grade waste heat is electronic components in a datacenter or a space platform.

22. The method of claim 19, wherein the cooling environment is ambient atmosphere, a fluid bath, or an interface with a coolant system.

23. The method of claim 19, wherein, during oscillating, the magnet is confined to a section of the conduit.
